(19) United States
(12) Patent Application Publication
(10) Pub. No.: US 2002/0192515 A1
(43) Pub. Date: Dec. 19, 2002

(54) Production of a securely adhering, hydrophobic catalyst layer

(75) Inventors: Patrick Bachinger, Dettingen (DE); Berthold Keppeler, Owen (DE); Dagmar Nowak, Winnenden-Hanweiler (DE); Thomas Roeser, Dettingen/Teck (DE); Michael Schmidt, Nurnberg (DE)

Correspondence Address: CROWELL & MORING LLP, INTELLECTUAL PROPERTY GROUP, P.O. BOX 14300, WASHINGTON, DC, 20044-4300, US

(73) Assignee: Ballard Power Systems AG.

(21) Appl. No.: 10/103,126

(22) Filed: Mar. 22, 2002

(30) Foreign Application Priority Data
Mar. 24, 2001 (DE) 101 14 646.9

(51) Int. Cl. H01M 8/04; C01B 31/20; H01M 8/06; B01J 23/00; B01J 31/00

(52) U.S. Cl. 429/20; 429/26; 423/437.2; 502/159; 502/300; 502/345; 502/355

(57) ABSTRACT

The invention relates to a process for producing a catalytic component on a metallic or ceramic support for a fuel cell system, in which the catalytic component is applied to the metallic or ceramic support in at least one layer. This at least one layer contains at least one hydrophobic material component, which is applied together or alternately with at least one catalytically active material component in one process step. The invention also relates to a catalytic component, which is applied to a metallic or ceramic support, for a chemical reactor in a fuel cell system, and to methods of using the catalytic component.

This application claims the priority of German Patent Document No. 101 14 646.9, filed Mar. 24, 2001, the disclosure of which is expressly incorporated by reference herein.

### BACKGROUND OF THE INVENTION

The invention relates to a method for producing a catalytic component on a metallic or ceramic support for a chemical reactor in a fuel cell system, and to a catalytic component and its use in a fuel cell.

EP 102033 A1 has described a process for producing a catalyst, in which a catalyst-containing material is mixed with a solvent and is deposited on a substrate which has been heated to above the boiling point of the solvent. A solvent and a powder comprising catalytically active material and/or catalytically coated support particles are used to produce a suspension. The suspension is sprayed in a defined way, in a spray material, onto the substrate, and a catalyst-containing layer is formed.

Furthermore, DE 197 17 067 C2 has described a reforming reactor installation which ensures a long service life of the catalyst material located in the reforming reactor. For this purpose, this installation, at the entry region of the first reactor, has a drop capture element, e.g. a metal nonwoven. When the gas/vapour mixture which is to be introduced into the reactor and is to be reformed, comprising methanol and water, passes through the metal nonwoven, any drops of methanol and water which may be formed are prevented from penetrating into the reforming reactor by the metal nonwoven. This avoids damage to the reforming material located in the reactor.

Furthermore, DE 197 21 751 C1 has disclosed a catalyst layer which has expansion joints in order to prevent the catalyst from flaking off or becoming detached from the support surface during operation of the catalyst layers.

During a cold start or in the event of a cold start being interrupted, catalytic layers in a gas generation system or a fuel cell system are often exposed to considerable formation of condensate originating from upstream components. This causes the formation of droplets or of a film of liquid, which is or are deposited on the catalytic layer. This makes it much more difficult to restart the catalytic layer, since this layer has to dry before restart can take place. The components of a gas generation system or a fuel cell system may, moreover, be exposed to mechanical or thermal stress, which at times also leads to the catalyst flaking off or being discharged from the layer.

Therefore, it is an object of the invention to provide a catalytic component and a process for producing a catalytic component which is substantially insensitive to the formation of condensate and to mechanical and/or thermal stress. A further object of the invention is to describe methods of using this component in a fuel cell system.

### SUMMARY OF THE INVENTION

This object is achieved by a catalytic component produced by a process comprising forming at least one catalyst layer on a metallic or ceramic support, wherein the at least one catalyst layer comprises at least one catalytically active material and at least one hydrophobic material, wherein said hydrophobic material is applied together or alternately with said at least one catalytically active material in one process step, and wherein the at least one layer having a porosity that is permeable to a gas medium, or a vapor medium or both.

The present invention also provides a catalytic component for a chemical reactor in a fuel cell system, wherein the catalytic component comprises a catalyst layer formed on a metallic or ceramic support, wherein said catalyst layer comprises at least one catalytically active material or a catalyst-containing material and at least one hydrophobic material, wherein the concentration of these two materials in the direction of the layer thickness is substantially constant and wherein said catalyst layer has a porosity that is permeable to a gas medium, a vapor medium or both.

Also disclosed are methods for catalytically burning a fuel, comprising burning said fuel in a catalytic burner comprising the catalytic component of the invention; methods for selectively oxidizing carbon monoxide (CO), comprising passing a gas mixture comprising CO through a reformer comprising the catalytic component of the invention; and methods for catalytically heating a heat exchanger of a fuel cell system, comprising feeding a fuel to a heat exchanger comprising a catalytic component of the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 diagrammatically depicts a catalytic component which has been applied to a support by washing, painting or printing.

FIG. 2 diagrammatically depicts a catalytic component which has been applied to a support by spraying.

FIG. 3 diagrammatically depicts a double layer which has been applied to a support by spraying, washing, painting or printing processes.

### DETAILED DESCRIPTION OF THE INVENTION

In the process according to the invention, a catalytic component for a chemical reactor in a fuel cell system is produced by applying the catalytic component to the metallic or ceramic support in at least one layer. This at least one layer contains at least one hydrophobic material component, which is applied together or alternately with the at least one catalytically active material component in one or more process steps, and this at least one layer has a porosity that is permeable to a gas or a vapour medium, or both.

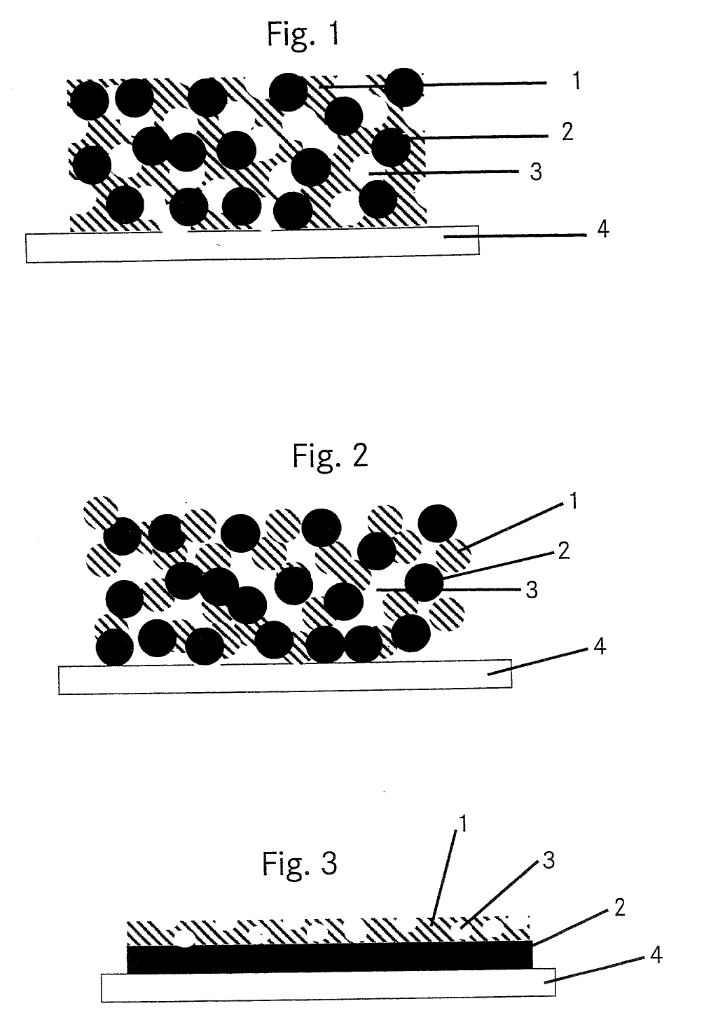

In one embodiment, as illustrated in FIG. 1, one layer of catalytic component is applied by application of a mixture of substances which contains at least one catalytically active material component (2) and at least one hydrophobic material component (1). In the process, the respective components are mixed in advance, if appropriate with the addition of a pore-forming agent, and are then applied to the metallic or ceramic support (4), which may be heated, in a manner which is known to an ordinarily skilled artisan by means of a washing, painting or printing process. The concentration profiles of the hydrophobic material component (1) and of the catalytically active material component (2), in the at least one layer, are gradient-free in the direction of the layer thickness, i.e. the concentrations of the two materials are substantially constant in the direction of the layer thickness in the at least one layer. This mixture may also be introduced into a fuel cell system, for example into a reformer, in the form of pellets or extrudates as bulk material.

By way of example, readily decomposable organic molecules, cellulose, carbonates, urea or propellant gases are suitable pore-forming agents. The layer which is applied to the metallic or ceramic support in this way using the washing, painting or printing process is then calcined. During the calcining operation, the substances which have been introduced as pore-forming agents decompose, and a system of interconnected pores with diameters of <10 μm is formed.

Drops of water generally have a diameter of >100 μm and therefore, on account of the hydrophobic properties of the surface, cannot penetrate through the porous layer without the application of an additional force, i.e. of a pressure. By contrast, gas exchange with the catalytically active material component (2) through the pores is possible. Therefore, the supply of starting materials in gas or vapour form to the catalytic layer and the removal of products in gas or vapour form from the catalytic layer is possible. The physical effect—the permeability to media in gas and/or vapour form but impermeability to liquid water—advantageously helps prevent the catalyst from becoming virtually completely covered with droplets and/or a film of liquid, for example through condensation of water vapour, and therefore to avoid a reduction in activity or deactivation of the catalyst, while nevertheless allowing the moisture balance of the layer to remain ensured.

In another embodiment, as illustrated in FIG. 2, this at least one layer of catalytic material is also produced by alternate spraying of the catalytically active material component (2) and of the hydrophobic material component (1) with a gradient-free concentration profile in the direction of the layer thickness. For this purpose, the individual spray heads, which are fed with the respective material component, are actuated at different times.

In a further embodiment of the process according to the invention, which is likewise illustrated by FIG. 2, the at least one layer of catalyst is produced by simultaneous application of the catalytically active material component (2) and of the hydrophobic material component (1) with a gradient-free concentration profile in the direction of the layer thickness. In this embodiment, the individual spray heads, which are fed with the respective material component, are actuated simultaneously. During the spraying operation, the metallic or ceramic support (4) is advantageously at a temperature of approximately 100 to 250° C., particularly preferably between approximately 180 and 200° C. The elevated temperature of the coated support causes the solvent fraction contained in the droplets of the spray mist to evaporate instantaneously on coming into contact with the support, so that the suspension which is to form the coating, produced from hydrophobic material component (1) and solvent, does not flow on the metallic or ceramic support (4), but rather is deposited in virtually spherical form on the surface.

The application of the hydrophobic material component (1) in the form of small spheres with diameters of approximately <1 μm leads to the formation of pores (3), the diameters of which are of the same order of magnitude as the diameters of the small spheres, between the spheres.

As has been outlined in connection with the previous process, in this case too the hydrophobic surface of the narrow pores prevents penetration of liquid water. Therefore, when the fuel cell is operating, the hydrophobic material component layer is advantageously permeable to gases and vapours but repels, for example, water droplets. This ensures that the reactivity of the catalyst is not impeded by the formation of condensate in cold parts of the fuel cell system or gas generation system, but rather has the highest possible availability in particular during a cold start.

Secondly, the bonding of the catalytic material component to the hydrophobic material component through adhesive bonding or crosslinking advantageously prevents the catalyst material from flaking off or being discharged or substantially reduces such effects.

As shown in FIG. 3, a method for producing a catalytic component is also conceivable in which, first of all, a lower layer, which contains the catalytically active material component, is applied to a support, and then an upper layer, which contains the hydrophobic material component, is applied to the lower layer. Both the lower layer, which contains the catalytic material component (2), and the upper layer, which contains the hydrophobic material component (1), can be produced by spraying in accordance with EP 102 033 A1, the entire disclosure of which is herein incorporated by reference. As described above, the special spraying process leads to the formation of pores. The double layer described in FIG. 3 can also be applied by a washing, painting or printing process well-known to those ordinarily skilled in the art. The physical effects outlined above are also employed in the production process described here.

The metallic supports used may be stainless steel or materials which contain stainless steel, aluminium or aluminium-containing materials, copper or copper-containing materials, while the ceramic supports used may be materials such as γ-aluminium oxide, zeolites, zinc oxide, Ca oxide, Mg oxide, Zr oxide, Ti oxide, Ce oxide. The supports themselves may, for example, be in the form of smooth, corrugated, serrated, honeycomb or any other suitable form.

The catalytically active component which is applied as a layer to a metallic or ceramic support contains at least one catalyst material component or at least one catalyst-containing material component and at least one hydrophobic material component. The concentration of these two materials in the direction of the layer thickness is substantially constant.

It is preferable for the catalytically active material selected to be metals from subgroups Ib, IIb, VIIb and/or VIIIb of the Periodical Table, while the material may additionally contain substances which are based on elements from other groups of the Periodical Table. The at least one catalyst material component or catalyst-containing material component is preferably present in supported form. There is a range of suitable support materials for catalysts, such as ceramic, carbon, plastic, metal, etc. Porous solids, on the surface of which catalytically active material has been deposited, are particularly suitable. It is particularly preferable for the support materials used to be ceramic materials, such as zeolites, Al₂O₃, SiO₂, ZrO₂, CeO₂ and/or mixtures thereof.

The at least one hydrophobic material preferably contains silicones or silicone-containing materials, fluorinated polymers, such as polytetrafluoroethylene or polytetrafluoroethylene-containing materials, epoxy resin or materials which contain epoxy resin, phenolic resin or materials which contain phenolic resin, acrylic resin or materials which contain acrylic resin, PUR adhesive materials or materials which contain PUR adhesive or synthetic resin/shellac mixtures or mixtures which contain synthetic resin/shellac. Within the range of the fluorinated polymers, polytetrafluoroethylene (PTFE) is a particularly suitable hydrophobic component and binder for catalysts. Within the range of the silicones, it is particularly preferable to use silicone resins, which must have a high long-term thermal stability within the range of use. These temperatures of use lie in the range between approximately 30° C. and 650° C., preferably in the range between approximately 50° C. and 300° C. It has proven to be a further advantage that, when precious metal is used as catalytically active material component in combination with silicones as hydrophobic material component, the catalyst is no longer poisonous, as is the case, for example, when copper is used as the catalytic component.

Moreover, it is extremely advantageous if the layer which contains the hydrophobic material component has an elasticity, brought about by the chemical substance itself and/or the application process. The elasticity prevents catalyst from flaking off or being discharged from the layer or substantially reduces such effects. The crosslinking of the hydrophobic material component also causes it to act as a binder for the catalyst. The proportion of hydrophobic material component, based on the catalytically active material component and/or catalyst-containing material component, is from 1 to 50 percent by weight, preferably 5 to 25 percent by weight.

Exemplary embodiments 1-3 for the production of a securely adhering, hydrophobic catalyst layer:

### EXAMPLE 1

A catalytically active layer is formed on a ceramic or metallic support by spray coating, as described in EP 102033. The catalyst suspension required for this purpose comprises at least one catalytically active material, a binder and water. Suitable binders are, for example, substances such as Al₂O₃, SiO₂, ZrO₂, CeO₂ and/or mixtures thereof. The mass ratio of binder to catalyst is in the range from 0.1:100 to 50:100, preferably in the range from 1:100 to 30:100. The mass ratio of solid (catalyst, binder) to water is in the range from 10:90 to 50:50. The spraying process used may be any desired process which is known from coatings technology. The layer thickness of the catalytically active layer is in the range from approximately 10 to 40 μm.

Then, a hydrophobic topcoat is applied above this catalyst or catalyst-containing layer. For this purpose, a suspension is produced from silicon (e.g. the high-temperature silicone Pactan produced by Bauchemie Heidelberg) and the solvent hexane in a ratio of 1:9. This suspension is sprayed onto the support, which has already been coated with catalyst, using any desired process which is known from coatings technology. During the spraying operation, the catalyst-coated support is advantageously at a temperature of 100 to 250° C. The elevated temperature of the support causes the solvent fraction contained in the droplets of the spray mist to evaporate suddenly when the mist comes into contact with the support, so that the suspension which is to form the coating does not flow on the surface which is to be coated, but rather virtually spherical silicone deposits are formed on the surface. This silicone layer can be used without decomposition in a temperature range up to approximately 150° C. during prolonged use of a fuel cell system.

### EXAMPLE 2

A catalytically active layer is formed on a ceramic or metallic support in the manner described in Example 1. Then, a hydrophobic topcoat is applied above this catalyst or catalyst-containing layer. A dilute Teflon suspension is produced from Teflon 30 B (60% strength aqueous Teflon suspension produced by DuPont) and water. The ratio of Teflon 30 B to water is in the range from 1:10 to 10:1, preferably in the range from 1:5 to 10:1. This suspension is applied to the catalyst layer by means of a spraying technique. During the spraying operation, the catalyst-coated support is likewise advantageously at a temperature of 100 to 250° C., particularly preferably at a temperature of between 180 and 200° C. The effects described in Example 1 prevent the Teflon suspension from flowing after spraying, and a Teflon layer with pores, the diameters of which are likewise in the range <1 μm, is formed. The highly hydrophobic properties of this layer mean that the drops of water remain on the layer, without penetrating into the highly hydrophilic catalyst layer which lies below the Teflon layer. The temperatures of use of the layer in long-term use are in a temperature range of up to 300° C. The double layer, comprising catalytically active layer (catalytically active material: approx. 10 mg of platinum) and hydrophobic layer (hydrophobic material component: Teflon), which has been produced in this way, is subjected to a catalytic test, in which a reformate gas from methanol reforming with a high H₂ content and further smaller contents of CO₂, CO, O₂, H₂O flows over this double layer. A CO conversion of approximately 60% is achieved at a reaction temperature of 240° C. and a hydrogen volumetric flow rate of 0.25 Nm³/h (s.t.p.). After more than 15 operating hours in long-term use, it was impossible to observe any deactivation of the catalyst. Moreover, after the catalytic test the layer combination had the same hydrophobic properties as before. On account of its catalytic activity, a double layer of this type according to the invention is advantageously suitable for use as catalyst for the selective oxidation of CO in a fuel cell system in order to remove CO from hydrogen-containing reformate. Moreover, the said double layer is eminently suitable for any composition of reformate, including those derived from other fuels, such as for example petrol, diesel, natural gas, ethanol.

### EXAMPLE 3

A catalytically active layer is formed on a ceramic or metallic support by spray coating, as described in Example 1. Then, a hydrophobic topcoat is applied above this catalytically active layer. For this purpose, a suspension is produced from silicone resin (e.g. the high-temperature silicone resin SILRES M50E produced by Wacker) and the solvent hexane, which suspension is sprayed onto the catalytically active layer, as described in Examples 1 and 2. The temperatures of use for this double layer in long-term use are in a temperature range up to approximately 350° C.

The layers which are produced using the processes of the ivnention are of particularly homogeneous structure and are therefore particularly insensitive to the formation of condensate and to mechanical and/or thermal stress at the location of use in a chemical reactor of a fuel cell system.

The device according to the invention can be used not only in a hydrogen fuel cell system, but also in reformate-operated or direct methanol fuel cell systems. The inventive device is particularly suitable for use in a catalytic burner, for selective oxidation of CO, in a reformer or a catalytically heated heat exchanger in a fuel cell system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for producing a catalytic component on a metallic or ceramic support for a chemical reactor in a fuel cell system, the process comprising:
forming at least one catalyst layer on the metallic or ceramic support, said at least one catalyst layer comprising at least one catalytically active material and at least one hydrophobic material, wherein said hydrophobic material is applied together or alternately with said at least one catalytically active material in one process step, and said at least one layer having a porosity that is permeable to a gas medium, or a vapor medium or both.

2. A process according to claim 1, wherein the at least one catalyst layer is produced by applying a mixture of the catalytically active material and the hydrophobic material.

3. A process according to claim 1, wherein the at least one catalyst layer is produced by alternate application of the catalytically active material and of the hydrophobic material.

4. A process according to claim 1, wherein the at least one catalyst layer is produced by simultaneous application of the catalytic material and of the hydrophobic material.

5. A process according to claim 1, wherein the at least one catalyst layer is formed in such a manner that the concentration of the catalytically active material and the hydrophobic material in the direction of the layer thickness is substantially constant.

6. A process according to claim 3, wherein the at least one catalyst layer is applied by spraying.

7. A process according to claim 4, wherein the at least one catalyst layer is applied by spraying.

8. A process according to claim 1, wherein the at least one catalyst layer is applied by painting, printing or washing.

9. A process according to claim 1, wherein the support is heated during the formation of the at least one catalyst layer.

10. A process according to claim 2, wherein the mixture further comprises a pore-forming agent.

11. A catalytic component for a chemical reactor in a fuel cell system, said catalytic component comprising a catalyst layer formed on a metallic or ceramic support, wherein said catalyst layer comprises at least one catalytically active material or a catalyst-containing material and at least one hydrophobic material, wherein the concentration of these two materials in the direction of the layer thickness is substantially constant and wherein said catalyst layer has a porosity that is permeable to a gas medium, a vapor medium or both.

12. A catalytic component according to claim 11, wherein said at least one catalytically active material or catalyst-containing material is present in supported form.

13. A catalytic component according to claim 11, wherein the at least one hydrophobic material is selected from the group consisting of silicone, a silicone-containing material, a fluorinated polymer, a material containing a fluorinated polymer, an epoxy resin, a material containing an epoxy resin, a phenolic resin, a material containing a phenolic resin, an acrylic resin, a material containing an acrylic resin, a PUR adhesive material, a material containing a PUR adhesive, a synthetic resin/shellac mixture, and a mixture containing synthetic resin and shellac.

14. A catalytic component according to one of claim 11, wherein the hydrophobic material has an amount of 1-50% by weight of that of the catalytically active material or the catalyst-containing material.

15. A catalytic component according to one of claim 14, wherein the hydrophobic material has an amount of 5-25% by weight of that of the catalytically active material or the catalyst-containing material.

16. A catalytic component according to claim 11, wherein the metallic support comprises a material selected from the group consisting of stainless steel, a material which contains stainless steel, aluminum, an aluminum-containing material, copper, and a copper-containing material.

17. A method for catalytically burning a fuel, comprising burning said fuel in a catalytic burner comprising the catalytic component of claim 11.

18. A method for selectively oxidizing CO, comprising passing a gas mixture comprising CO through a reformer comprising the catalytic component of claim 11.

19. A method for catalytically heating a heat exchanger of a fuel cell system, comprising feeding a fuel to a heat exchanger comprising a catalytic component of claim 11.
